(19) United States
(12) Patent Application Publication
(10) Pub. No.: US 2018/0205181 A1
(43) Pub. Date: Jul. 19, 2018

(54) HIGH SPEED CABLE ASSEMBLY

(71) Applicant: Alltop Electronics (Suzhou) Ltd., Taicang City (CN)

(72) Inventors: Yi-Chang CHEN, JHONGHE City (TW); Mao-Jung HUANG, JHONGHE City (TW)

(73) Assignee: ALLTOP ELECTRONICS (SUZHOU) LTD., Taicang City (CN)

(21) Appl. No.: 15/685,112

(22) Filed: Aug. 24, 2017

(30) Foreign Application Priority Data
Jan. 18, 2017 (CN) 201720055085.2
Jan. 18, 2017 (CN) 201720055101.8
Jan. 18, 2017 (CN) 201720055102.2

(51) Int. Cl. H01R 13/6585; H01R 13/627; H01R 13/6598; H01R 13/6592; H01R 13/6471; H01B 7/08; H01B 11/00

(52) U.S. Cl. CPC H01R 13/6585; H01R 13/627; H01R 13/6598; H01B 7/0861; H01R 13/6471; H01B 7/0807; H01B 11/002; H01R 13/6592

(57) ABSTRACT

A high speed cable assembly includes a ribbon cable and a high speed connector. The ribbon cable includes a number of wires and a jacket enclosing the wires. Each wire has a central conductor and a shielding layer covering the conductor. The ribbon cable provides differential pairs of wires and drain wires, each drain wire positioned next to one differential pair of wire. The high speed connector has an insulating housing, and a printed circuit board assembled within the insulating housing. The printed circuit board is provided with first group of golden fingers on one end thereof, which are formed to electrically connect to the wires of the ribbon cable, respectively, and second group of golden fingers on the other end thereof, which are configured to form an I/O interface for transmitting high speed signals to a complementary connector.

This patent application is a continuation-in-part application of U.S. patent application Ser. No. 14/926,849, filed on Oct. 29, 2015, entitled “CABLE CONNECTOR”, which is assigned to the same assignee as this application and is incorporated by reference herein in its entirety.

### BACKGROUND

### 1. Technical Field

The present disclosure relates to a cable assembly, and more particularly to a high speed cable assembly.

### 2. Description of Related Art

Due to increasing data transmission speeds used in modern electronic devices, ribbon cables which effectively transmit high speed signals are desired. Conventional ribbon cable is composed by a plurality of wires, each wire including a central conductor surrounded by an insulator. The insulator is enclosed by a shield. The plurality of wires are always surrounded by a jacket. Generally, the ribbon cable comprises differential wires and grounding wires next to the differential wires. High speed cable assembly including two high speed connectors and the ribbon cable connecting between the two high speed connectors is desired and developed in nowadays.

### SUMMARY

Accordingly, it is an object of the invention to provide a high speed cable assembly. The high speed cable assembly comprises a ribbon cable and a high speed connector connecting with the ribbon cable. The ribbon cable includes a plurality of wires and a jacket enclosing the plurality of wires. Each wire has a central conductor and a shielding layer covering the central conductor. The ribbon cable provides a plurality of differential pairs of wires and a plurality of drain wires, each drain wire positioned next to one differential pair of wire. The high speed connector has an insulating housing, and a printed circuit board assembled within the insulating housing. The printed circuit board is provided with first group of golden fingers on one end thereof, which are formed to electrically connect to the wires of the ribbon cable, respectively, and second group of golden fingers on the other end thereof, which are configured to form an I/O interface for transmitting high speed signals to a complementary connector.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a high speed cable assembly in accordance with an illustrated embodiment of the present invention;

FIG. 2 is a perspective view of a ribbon cable shown in FIG. 1;

FIG. 3 is a cross-section view of the ribbon cable shown in FIG. 2;

FIG. 4 is a perspective view of a first connector shown in FIG. 1;

FIG. 5 is an exploded view of the first connector shown in FIG. 4;

FIG. 6 is a perspective view of a base section of the first connector shown in FIG. 5;

FIG. 7 is a perspective view of a latch of the first connector shown in FIG. 5;

FIG. 8 is a perspective view of a cover section of the first connector shown in FIG. 5;

FIG. 9 is a perspective view of a second connector shown in FIG. 1;

FIG. 10 is an exploded, perspective view of the second connector shown in FIG. 9;

FIG. 11 is a perspective view of a base section of the second connector shown in FIG. 10;

FIG. 12 is a perspective view of a latch of the second connector shown in FIG. 10;

FIG. 13 is a view showing the first and the second printed circuit boards connected by the ribbon cable;

FIG. 14 is a perspective view of a high speed cable assembly in accordance with a second embodiment of the present invention;

FIG. 15 is a perspective view of the first connector of the second embodiment shown in FIG. 14;

FIG. 16 is an exploded, perspective view of the first connector shown in FIG. 15;

FIG. 17 is a perspective view of a base section of the first connector shown in FIG. 16;

FIG. 18 is a perspective view of a cover section of the first connector shown in FIG. 16;

FIG. 19 is a perspective view of the second connector of the second embodiment shown in FIG. 14;

FIG. 20 is a perspective view of a high speed cable assembly in accordance with a third embodiment of the present invention;

FIG. 21 is a perspective view of the first connector shown in FIG. 20; and

FIG. 22 is a perspective view of a spacer shown in FIG. 20.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

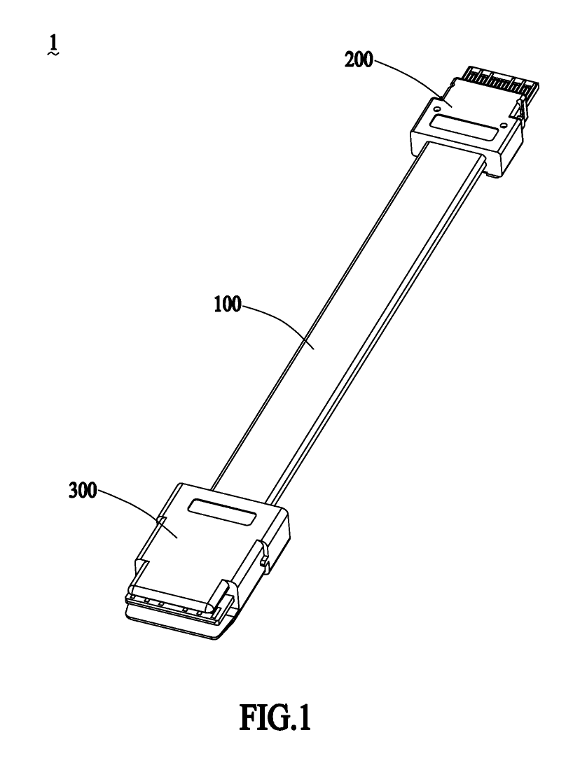

Referring to FIG. 1, an illustrated embodiment of the present invention discloses a high speed cable assembly 1 comprising a pair of ribbon cables 100, a first connector 200 and a second connector 300 connecting to two opposite ends of the ribbon cables 100, respectively. The first connector 200 and the second connector 300 shown in first embodiment, transmit high speed signals and are performed as I/O connectors.

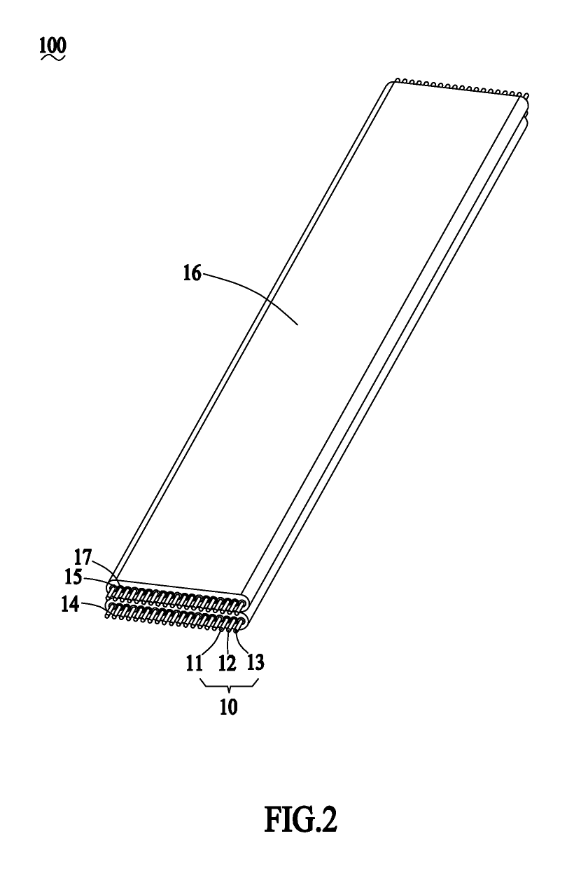

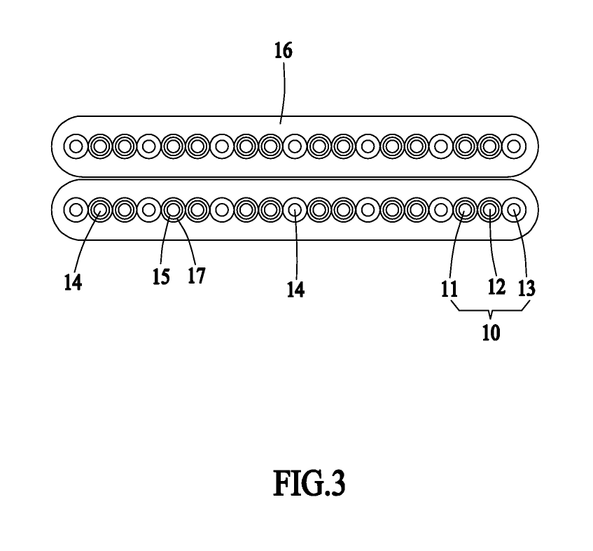

Referring to FIGS. 2 and 3, the ribbon cable 100 comprises a plurality of wires 10 arranged in a row and an insulative jacket 16 enclosing the row of wires 10. The wires 10 include a first kind of wires 11, a second kind of wires 12 and a third kind of wires 13. The first and the second kinds of wires 11, 12 are designed to transmit high speed signals and the third kind of wires 13 is designed as a drain wire. In this preferred embodiment, the first and the second kinds of wires 11, 12 perform as a differential signal pair. Each drain wire 13 is located near the differential signal pair of wires 11, 12 and isolates two adjacent differential pairs of wires 11, 12.

The plurality of wires 10 each have a central conductor 14 and a shielding layer covering the central conductor 14. The shielding layer of each of the differential signal pair of wires 11, 12 includes an inner insulative layer 15 and an outer insulative layer 17. In this preferred embodiment, the electric permittivity of the inner insulative layer 15 is smaller than that of the outer layer 17. In details, the inner insulative layer 15 is formed from material, the electric permittivity of which is between 2.1˜2.4. The outer insulative layer 17 is a wave-absorbing layer which protects the central conductor 14 from undesired electromagnetic wave from outside. The central conductor 14 of the drain wire 13 has a same diameter of the central conductor 14 of the differential signal pair of wires 11, 12. While, in other applied environments, the diameter of the central conductor 14 of the drain wire 13 can be designed different from that of central conductors of the signal wires 11, 12. Besides, the drain wire 13 can have only one insulative layer instead of two layers. The insulative jacket 16 encloses the plurality of wires 10, which can be made from Thermoplastic Elastomer (TPE) material. The wires 10 are arranged in one row and distances of the central conductors are equal.

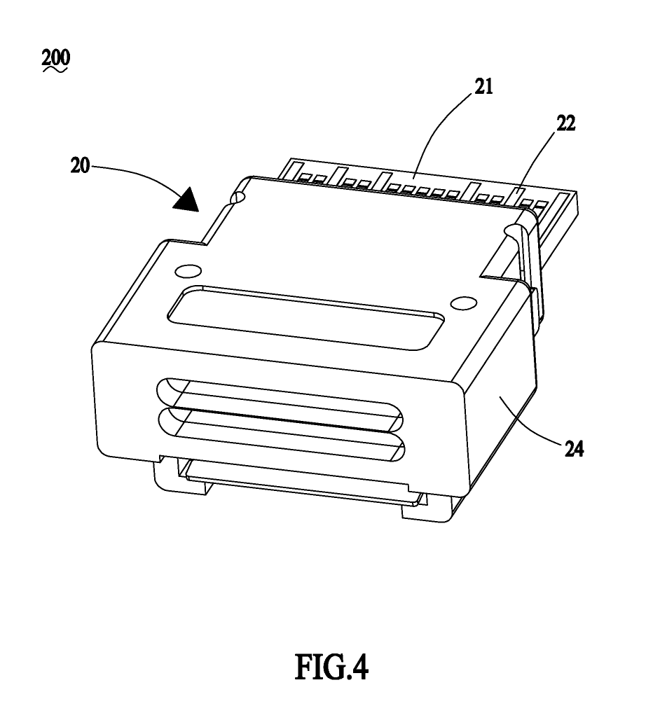

Turing to FIG. 4, the first connector 200 comprises a first dielectric housing 20 and a first printed circuit board 21 received within the first dielectric housing 20. The first printed circuit board 21 comprises two groups of golden fingers 22 positioned at two opposite ends thereof. The first group of golden fingers 221 electrically and mechanically connect to the central conductors 14 of the ribbon cable 100. The second group of golden fingers 222 are exposed from the dielectric housing 20 and configured to be an I/O interface. In this preferred embodiment, the I/O interface is a Slimline SAS interface. As can be easily understood, the group of golden fingers 22 are located at two opposite top surface and bottom surface of the printed circuit board 21.

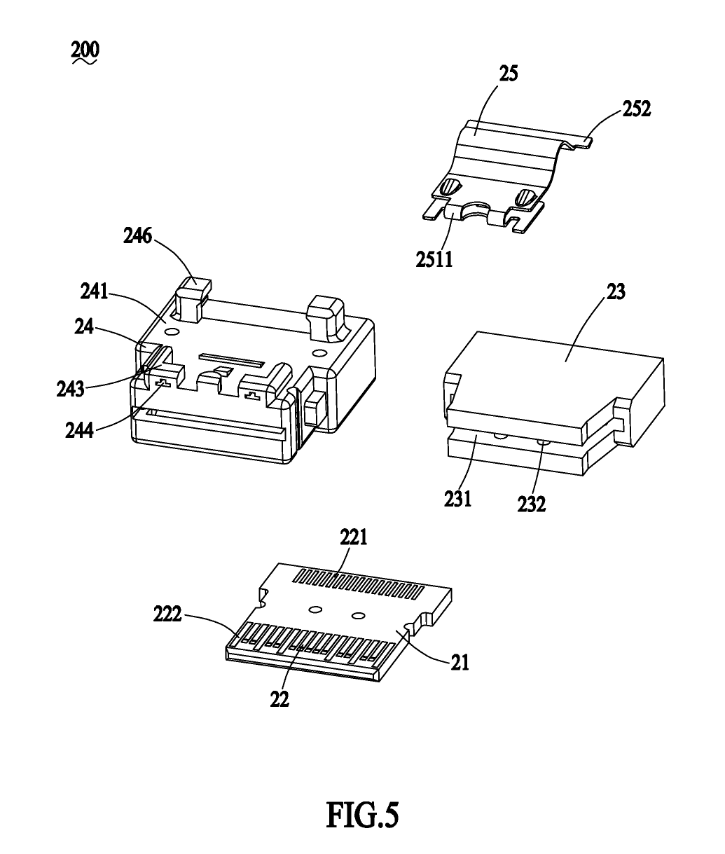

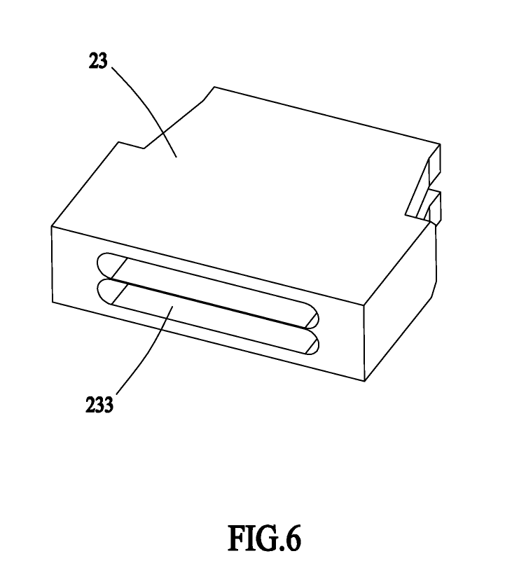

Referring to FIGS. 5 and 6, the first dielectric housing 20 comprises a base section 23 retaining therein the first printed circuit board 21 and the ribbon cable 100, and a cover section 24 enclosing the base section 23. The base section 23 defines a first receiving room 231 for extending therethrough the first printed circuit board 21. A pair of protrusions 232 are formed in the first receiving room 231, which are engaging with holes (not labeled) of the first printed circuit board 21 to thereby limit and secure the board 21 within the receiving room 231. The receiving room 231 includes a front opening opened for the printed circuit board 21 exposed the second group of golden fingers 22, and a back opening 233 opened for extending therethrough the ribbon cable 100. In the preferred embodiment, the back opening 233 is divided into two parts located along a thickness direction for respectively receiving the pair of ribbon cables 100.

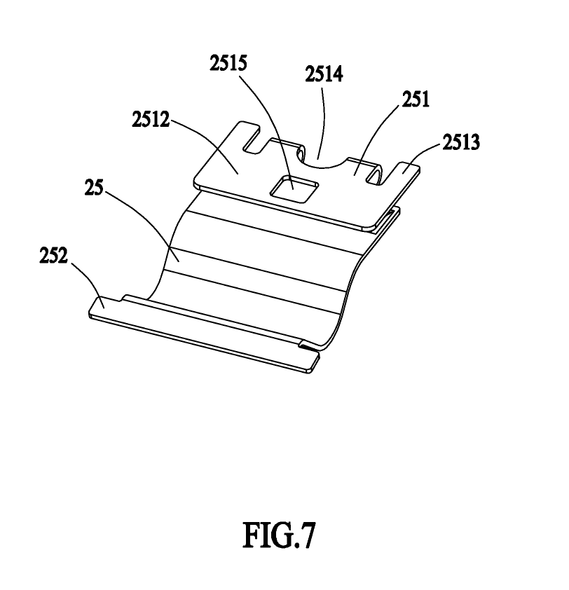

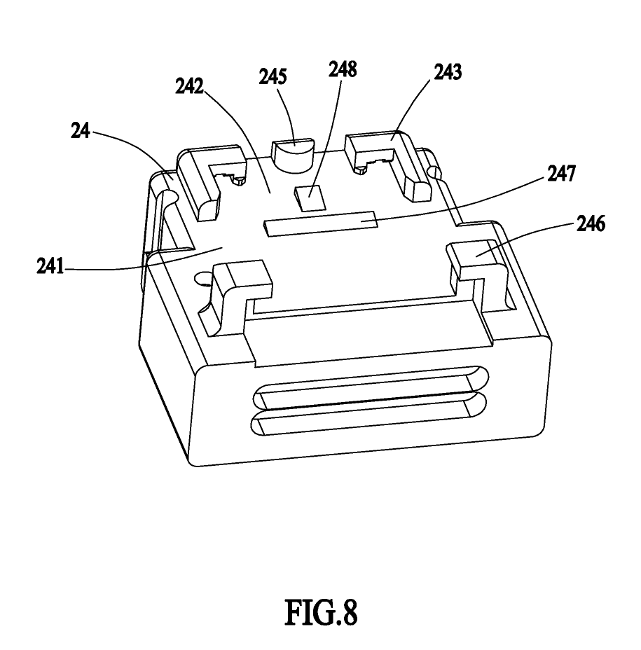

Referring to FIGS. 7 and 8 together with FIG. 5, the first connector 200 includes a latch 25 assembled on a bottom surface 241 of the cover section 24, which is employed to secure the connection between the first connector with a complementary connector. The latch 25 is formed with a retaining portion 251 at a front end and a holding portion 252 at a rear end thereof. The retaining portion 251 has a U-shaped resilient portion 2511 connecting with the holding portion 252, a backward extension portion 2512 and a forward extension portion 2513. The forward extension portion 2513 is provided with two protrusions located at two opposite sides of the U-shaped resilient portion 2511. In the middle of the U-shaped resilient portion 2511, a U-shaped slot 2514 is defined. The cover section 24 is provided with a pair of L-shaped blocks 243 on a bottom surface 241 thereof and a retaining recess 242 defined between the pair of L-shaped blocks 243 for receiving the retaining portion 251 of the latch 25. Each L-shaped block 243 defines therethrough a slit 244 for extension of the two forward extension protrusions 2513 of the latch 25. A limiting block 245, which is semicylindrical, is formed at a front edge of the bottom surface 241 and located between the two L-shaped blocks 243. The limiting block 245 engages within the U-shaped slot 2514 to thereby limit the latch 25 in an original position. A pair of holding blocks 246 are provided on the bottom surface 241 opposite to the two L-shaped blocks 243. The holding portion 252 of the latch 25 is movably received and held between the corresponding two holding blocks 243 and the bottom surface 241. The U-shaped portion 251 provides a resilience to the latch 25 which makes the holding portion 252 movable with respect to the retaining portion 251. In a middle of the backward extension portion 2512, a rectangular cutout 2515 is defined. On the bottom surface 241, a horizontal positioning projection 247 and a rectangular projection 248 are formed. The rectangular projection 248 is assembled within the rectangular cutout 2515 of the latch 25 and an edge of the backward extension portion 2512 abuts against the horizontal positioning projection 247. In the preferred embodiment, the horizontal positioning projection 247 and the rectangular projection 248 both have a slanted surface thereof.

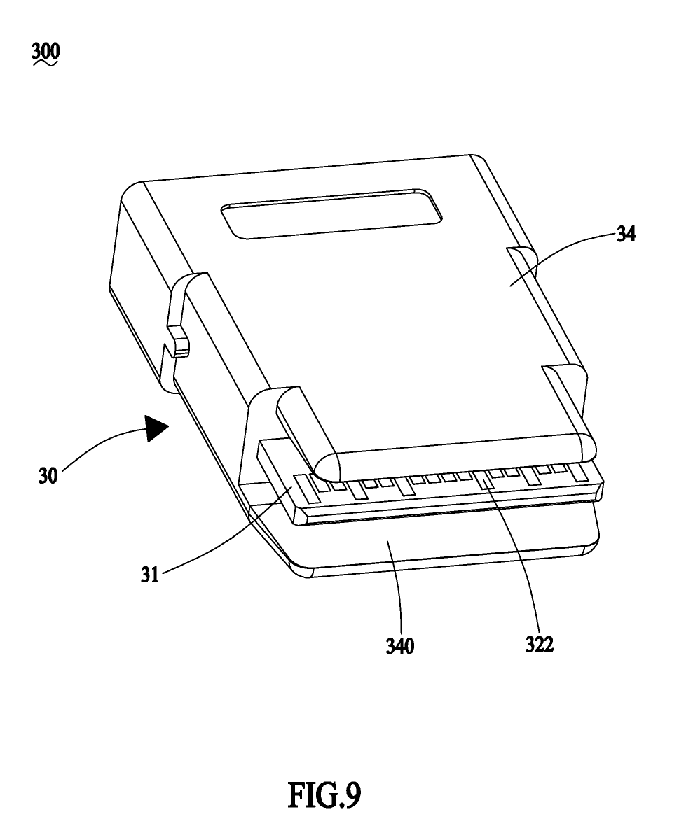

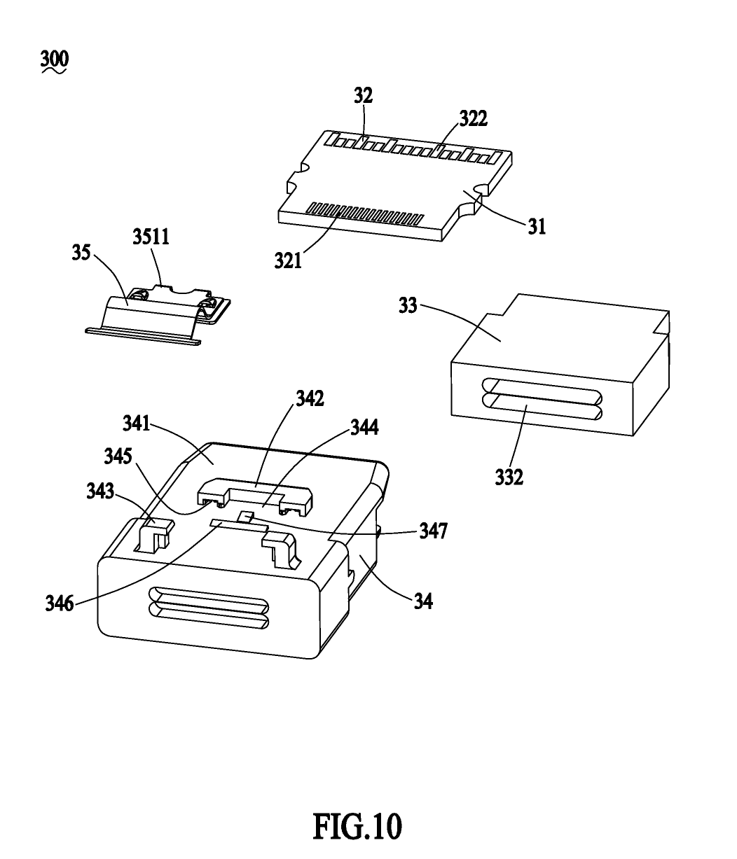

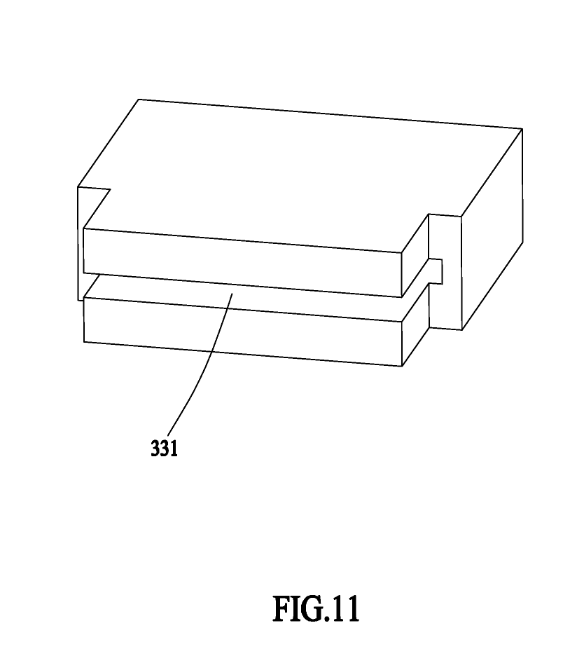

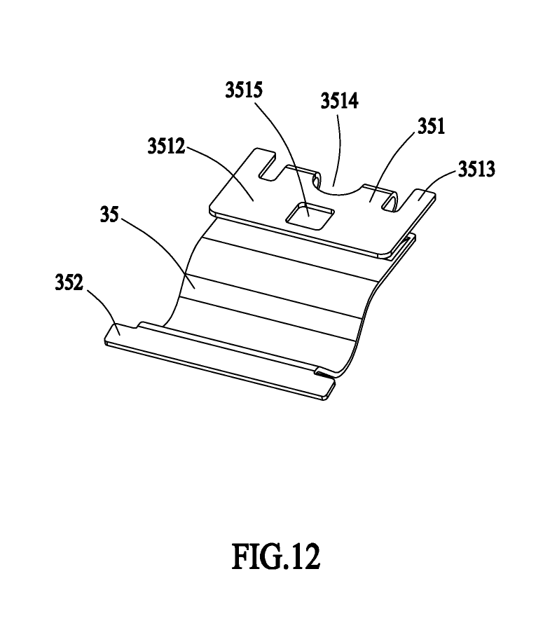

Turning to FIGS. 9-12, the second connector 300 comprises a second dielectric housing 30 and a second printed circuit board 31 received in the second dielectric housing 30. The second printed circuit board 31 comprises two groups of golden fingers 32 positioned at two opposite ends thereof. The first group of golden fingers 321 electrically and mechanically connect to the central conductors 14 of the ribbon cable 100. The second group of golden fingers 322 are exposed from the dielectric housing 30 and configured to be an I/O interface. In this preferred embodiment, the I/O interface is a Mini SAS interface. As can be easily understood, the group of golden fingers 32 are located at two opposite top surface and bottom surface of the second printed circuit board 31. The second dielectric housing 30 comprises a second base section 33 retaining therein the second printed circuit board 31 and the ribbon cable 100, and a second cover section 34 enclosing the second base section 33. The second base section 33 defines a second receiving room 331 for extending therethrough the second printed circuit board 31. The second receiving room 331 includes a second front opening 331 opened for extension of the second printed circuit board 31, and a second back opening 332 opened for extending therethrough the ribbon cable 100. In the preferred embodiment, the second back opening 332 is divided into two parts located along a thickness direction for respectively receiving the pair of ribbon cables 100. The second cover section 34 defines an engaging space 340 at a front end thereof in which the second printed circuit board 31 is exposed for engaging with a complementary connector.

The second connector 300 also has a second latch 35 assembled on the second cover section 34. The second latch 35 is formed with a second retaining portion 351 and a second horizontal extended, holding portion 352. The second retaining portion 351 comprises a second U-shaped resilient portion 3511, a second backwards extended portion 3512 and a second forwards extended portion 3513. The second forwards extended portion 3513 is provided with two protrusions located at two opposite sides of the second U-shaped resilient portion 3511. In the middle of the second U-shaped resilient portion 3511, a second U-shaped slot 3514 is defined. The second cover section 34 is provided with a N-shaped limiting block 342 on a bottom surface 341 thereof and a pair of holding blocks 343 opposite to the N-shaped block 342. A retaining recess 344 is defined by the N-shaped block 342 for receiving the second retaining portion 351. The N-shaped block 342 defines therethrough a pair of slits 345 for extension of the two second forwards extended protrusions 3513. The two holding blocks 343 are positioned adjacent to a rear end of the second cover section 34 and located opposite to each other. The second holding portion 352 is engaged and limited by the two holding blocks 343. In a middle of the second backwards extended portion 3512, a rectangular cutout 3515 is defined. On the bottom surface 341, a horizontal positioning projection 346 and a rectangular projection 347 are formed. The rectangular projection 347 is assembled within the rectangular cutout 3515 of the latch 35 and an edge of the second backwards extended portion 3512 abuts against the horizontal positioning projection 346. In the preferred embodiment, the horizontal positioning projection 346 and the rectangular projection 347 both have a slanted surface thereof. By corresponding engagements between the second holding portion 352 and the two holding blocks 343, the U-shaped resilient portion 3511 and the retaining recess 344, the two second forwards extended protrusions 3513 and the retaining slits 345, the second backwards extended portion 3512 and the horizontal positioning projection 346, and the engagement between the rectangular cutout 3515 and the rectangular projection 347, the second latch 35 is firmly secured on the bottom surface 341 of the second cover section 34.

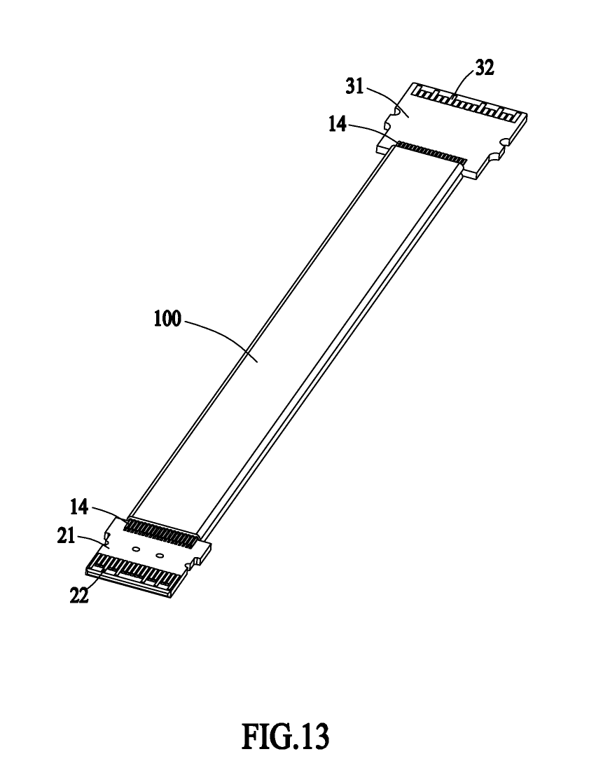

Referring to FIG. 13, the central conductors 14 of one end of the ribbon cable 100 electrically and mechanically connect to the first group of the golden fingers 221 of the first circuit board 21, and the central conductors 14 of the other end of the ribbon cable 100 electrically and mechanically connect to the first group of the golden fingers 321 of the second circuit board 31. The electrical connection between the first connector 200 and the second connector 300 is established. In this preferred embodiment, two ribbon cables 100 are employed, which are staggered arranged one on the other, so that the central conductors 14 of the two ribbon cables 100 can be connected to the golden fingers 22, 32 on two opposite upper and lower sides of the circuit boards 21, 31, respectively. Moreover, in this embodiment, the second connector 300 has a Mini SAS interface. While, in other embodiments, the second connector 300 can have other types of interface such as SATA 7PIN or Mini SAS HD, etc.

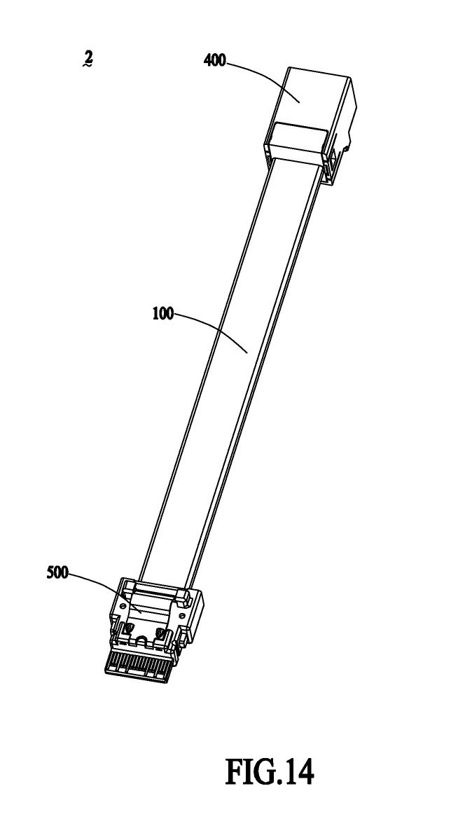

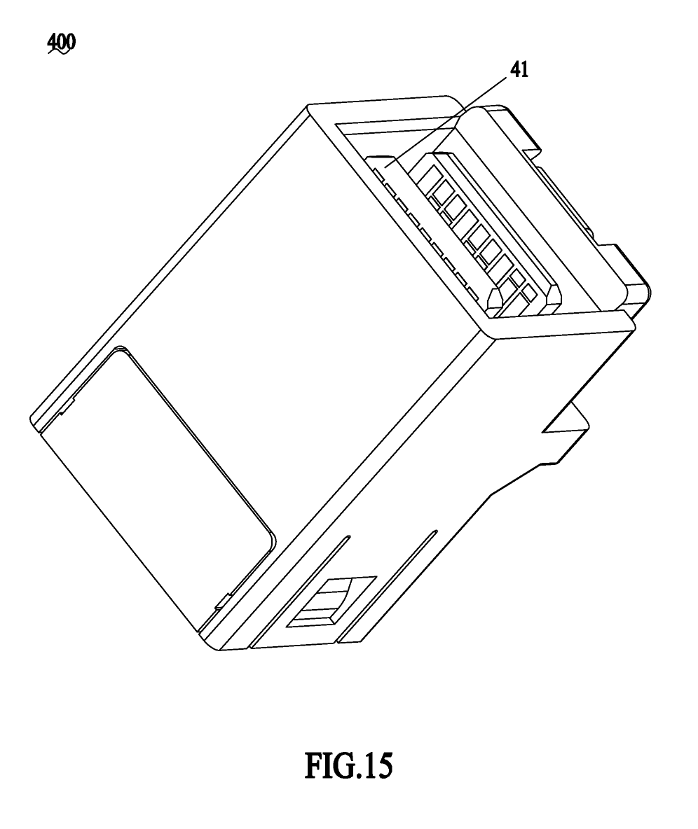

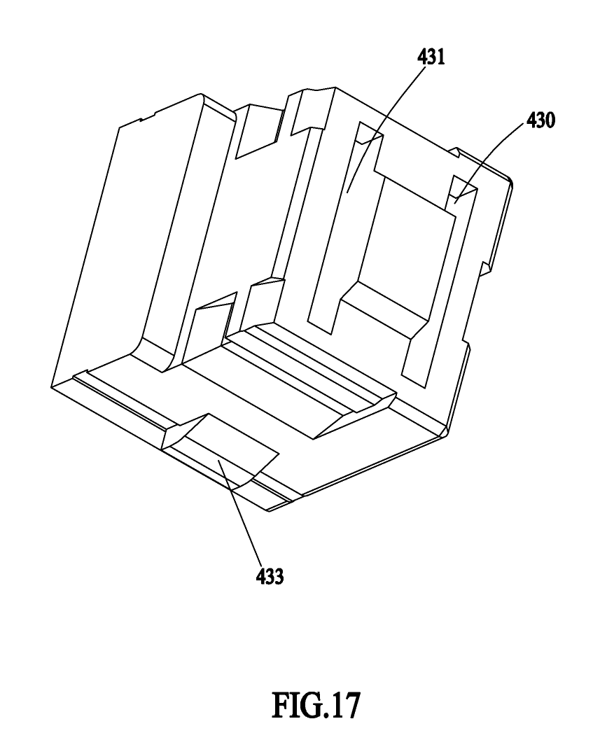

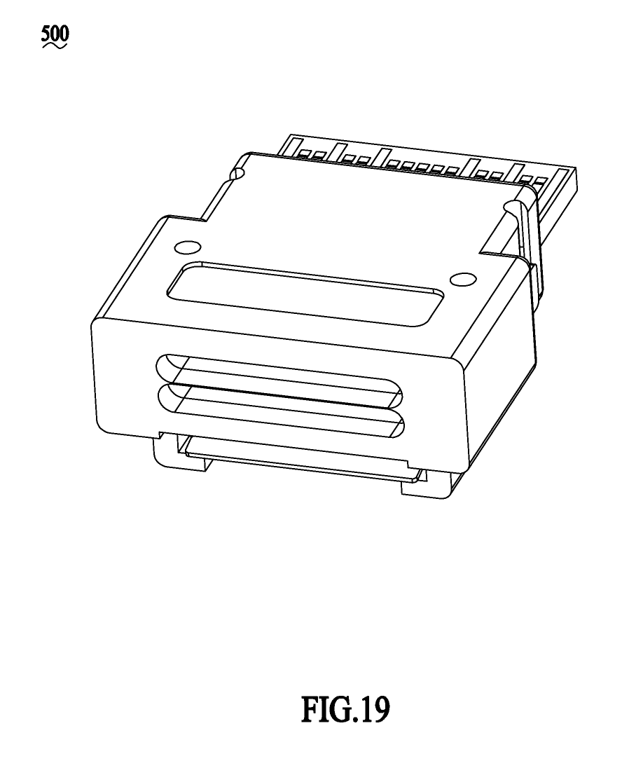

FIGS. 14-19 illustrate the second embodiment of the high speed cable assembly 2 of the present invention. The high speed cable assembly 2 employs a pair of ribbon cables 100, and a first connector 400 and a second connector 500 connecting to two opposite ends of the pair of ribbon cables 100, respectively. In this second embodiment, the first connector 400 has a Mini SAS HD interface and the second connector 500 has a Slimline SAS interface complying with SFF-8654 draft standard. As can be easily seen that the second connector 500 can have other types of interface such as SATA 7PIN or Mini SAS, etc., which is connecting to the ribbon cable 100 and transmitting signals to the first connector 400.

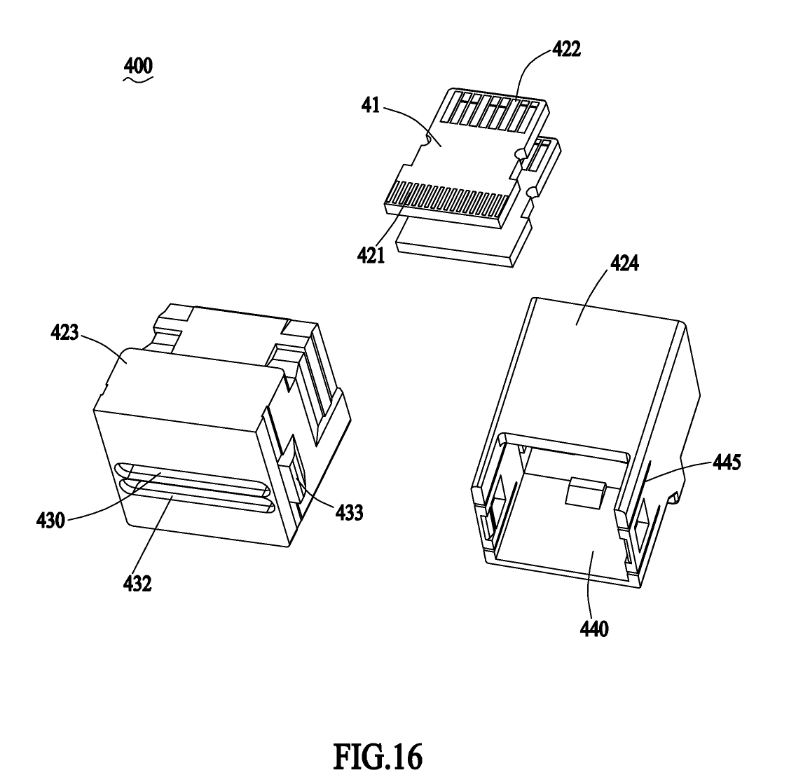

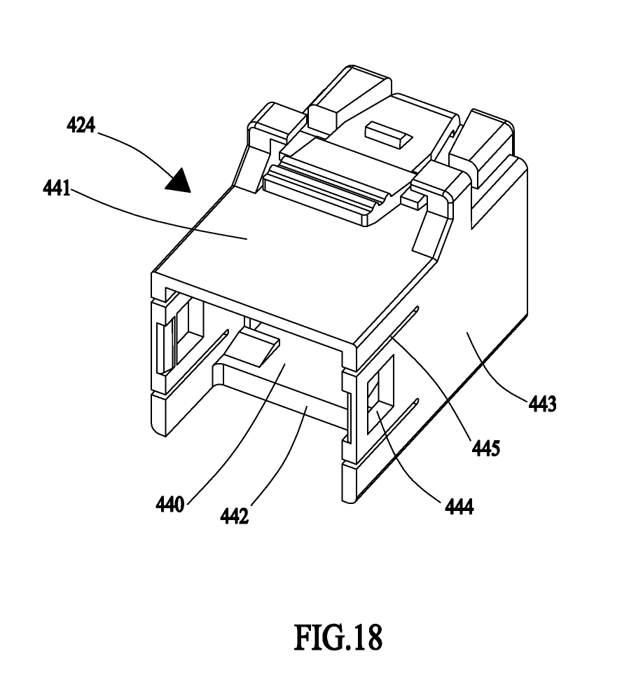

Referring to FIG. 16, similarly, the first connector or the Mini SAS HD connector 400 comprises a base 423 and a cover 424 enclosing the base 423. The base 423 provides a receiving room 430 extending therethrough for interconnecting the pair of the ribbon cables 100 and a pair of printed circuit boards 41. Each printed circuit board 41 comprises two groups of golden fingers 421, 422 positioned at two opposite ends thereof. The first group of golden fingers 421 electrically and mechanically connect to the central conductors 14 of the ribbon cable 100. The second group of golden fingers 422 are exposed from the cover 424 and configured to be Mini SAS HD interface. The receiving room 430 defines two front openings 431 stacked for extension of the pair of printed circuit boards 41 and two back openings 432 stacked for extending of the pair of ribbon cables 100, respectively. The distance between the two front openings 431 is larger than the distance between the two back openings 432. Turning to FIG. 18, the cover 424 defines a hollow space 440 for enclosing the base 423 which is formed by a top wall 441, a bottom wall 442 and a pair of side walls 443. Each side wall 443 defines thereon a window 444. Correspondingly, the base 423 forms a pair of wedges 433 located on two side surfaces thereof. Each wedge 433 is designed to engage within the window 444 of the side wall 443. Each side wall 443 of the cover 424 defines a pair of slits 445 parallelly extending along a front-to-back direction between which the window 445 is positioned. The pair of slits 445 provides resilience to the window 444, especially, when the wedge 433 fits within corresponding window 444.

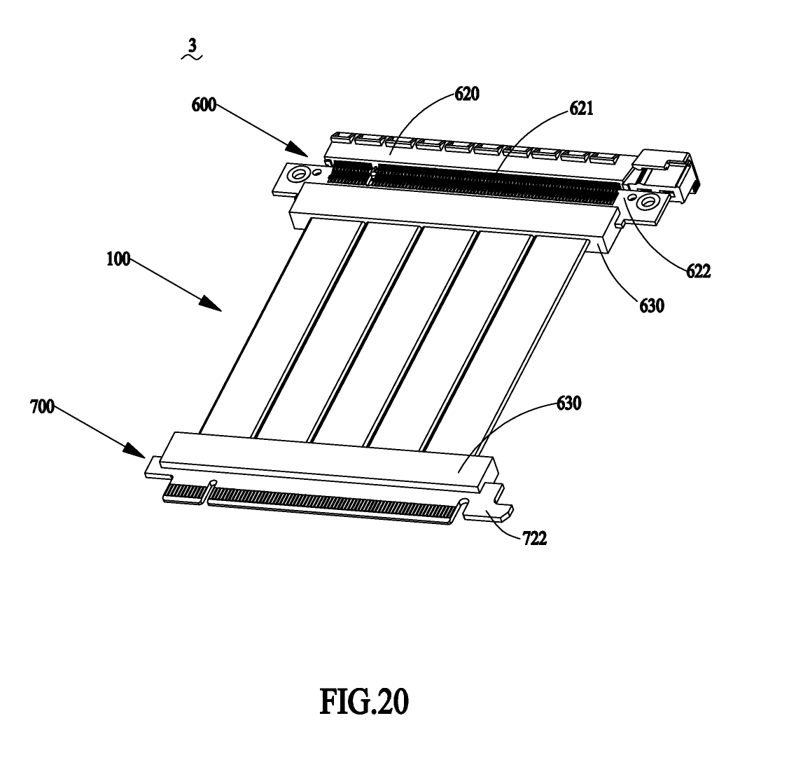

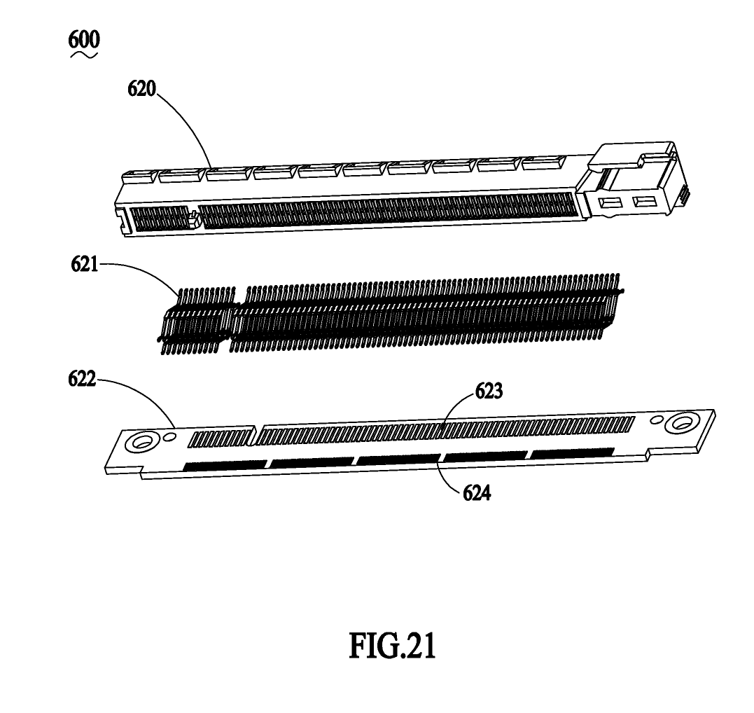

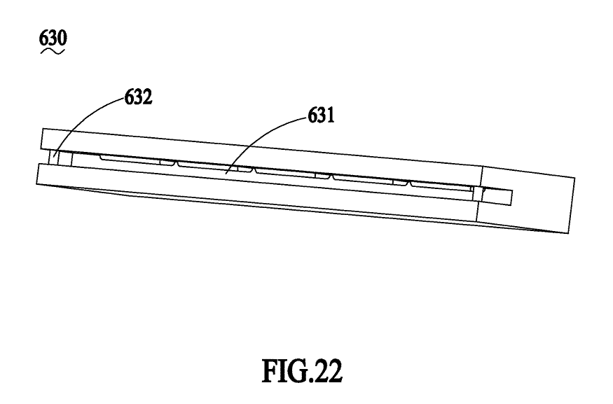

FIGS. 20-22 illustrate a third embodiment of the present invention. The main difference of the invention of the third embodiment is that the first connector 600 is configured to electrically and mechanically connect to a complementary connector with standard PCIe interface. The high speed cable assembly 3 of the third embodiment employs a plurality of ribbon cables 100, and the first connector 600 and a second connector 700 connecting to two opposite ends of the ribbon cables 100, respectively. The second connector 700 can have any one type of interface such as SATA 7PIN or Mini SAS, etc., which is connecting to the ribbon cable 100 and transmitting signals to the first connector 600 by a printed circuit board 722.

The first connector 600 comprises an insulating housing 620, a plurality of conductive contacts 621 and a printed circuit board 622 assembled within the insulating housing 620. The printed circuit board 622 provides a first group of golden fingers 623 on one end thereof and a second group of golden fingers 624 on the other end. The first group of golden fingers 623 electrically connect to the wires of the plurality of ribbon cables 100. The second group of golden fingers 624 electrically and mechanically connect with the conductive contacts 621, respectively. It should be noted here that the ribbon cables 100 of the three embodiments are same. The high speed cable assembly 3 also provides a pair of spacers 630 for facilitating the positioning of the printed circuit boards 622, 722, since the first connector 600 of the standard PCIe interface has a relatively long housing 620. The spacer 630 defines an elongated slot 631 for receiving an edge of the print circuit board 622, 722. A pair of posts 632 extend within the elongated slot 631 for cooperating with corresponding holes (not shown) of the printed circuit board 722 to thereby secure the printed circuit board 722.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

1. A high speed cable assembly, comprising:
at least one ribbon cable comprising a plurality of wires and a jacket enclosing said plurality of wires, each of said wires comprising a central conductor and a shielding layer covering said central conductor, said at least one ribbon cable comprising a plurality of differential pairs of wires and a plurality of drain wires, each drain wire positioned next to at least one differential pair of wire; and
a high speed connector connecting to said at least one ribbon cable, said high speed connector comprising an insulating housing, and at least one printed circuit board assembled within said insulating housing, said at least one printed circuit board provided with a first group of golden fingers on one end thereof, which are formed to electrically connect to said plurality of wires of said at least one ribbon cable, respectively, and a second group of golden fingers on the other end thereof, which are configured to form an I/O interface for transmitting high speed signals;
wherein said shielding layer includes a wave-absorbing layer.

2. The high speed cable assembly as claimed in claim 1, wherein said shielding layer includes an inner insulative layer and an outer insulative layer, and wherein said outer insulative layer is said wave-absorbing layer.

3. The high speed cable assembly as claimed in claim 2, wherein said inner insulative layer is formed by an insulative material, the electric permittivity of which is between 2.1˜2.4.

4. The high speed cable assembly as claimed in claim 3, wherein said insulating housing of said high speed connector comprises a base and a cover enclosing said base, said base providing a receiving room extending therethrough for interconnecting said at least one printed circuit board and said at least one corresponding ribbon cable therein.

5. The high speed cable assembly as claimed in claim 4, wherein said at least one printed circuit board defines a pair of holes thereon and wherein said base forms a pair of protrusions extending within said receiving room for engaging with said pair of holes to thereby secure said at least one printed circuit board.

6. The high speed cable assembly as claimed in claim 4, wherein said receiving room defines a front opening for extension of said at least one printed circuit board and a back opening for extending of said at least one ribbon cable.

7. The high speed cable assembly as claimed in claim 6, wherein said first group of golden fingers are arranged into two rows, one row of which is positioned on a top surface of said at least one printed circuit board, and other one row of which is positioned on a bottom surface thereof opposite to said top surface.

8. The high speed cable assembly as claimed in claim 7, wherein said high speed connector is provided with a latch assembled on a bottom surface of said cover, and said latch is employed to secure the connection between said high speed connector with a complementary connector.

9. The high speed cable assembly as claimed in claim 8, wherein said latch is made of metal material and comprises a retaining section secure in the front of said a bottom surface of said cover and a holding section extending backwards from said retaining section, and wherein said retaining section has a U-shaped portion providing a resilience to said latch which makes said holding section movable with respect to said retaining section along an upper-to-down direction.

10. The high speed cable assembly as claimed in claim 3, further comprising a cable end connector, which is electrically connected with said high speed connector by said at least one ribbon cable.

11. The high speed cable assembly as claimed in claim 10, wherein said I/O interface is designed as a Slimline SAS interface.

12. The high speed cable assembly as claimed in claim 10, wherein said I/O interface is designed as a Mini SAS HD interface.

13. The high speed cable assembly as claimed in claim 12, wherein said I/O interface is designed as a Mini SAS interface.

14. The high speed cable assembly as claimed in claim 13, wherein said receiving room defines two front openings stacked for extension of said pair of printed circuit boards and two back openings stacked for extending of said pair of ribbon cables.

15. The high speed cable assembly as claimed in claim 14, wherein a distance between two front openings is larger than a distance between two back openings.

16. The high speed cable assembly as claimed in claim 13, wherein said cover defines a hollow space for enclosing said base formed by a top wall, a bottom wall and a pair of side walls, and each side wall defines thereon a window, and wherein said base forms a pair of wedges located on two side surface thereof, and each wedge is engageable within said window of said side wall.

17. The high speed cable assembly as claimed in claim 16, wherein each of said side wall of said cover defines a pair of slits parallel extending along a front-to-back direction and wherein said window is positioned between said pair of slits.

18. The high speed cable assembly as claimed in claim 3, wherein the high speed connector further comprises a plurality of conductive contacts connecting to the second group of golden fingers, respectively.

19. The high speed cable assembly as claimed in claim 18, wherein the second group of golden fingers and the conductive contacts contribute to a standard PCIe (peripheral component interconnect express) interface.

20. The high speed cable assembly as claimed in claim 19, further comprising a spacer for facilitating the positioning of the at least one printed circuit board.
